(19) United States
(12) Patent Application Publication
(10) Pub. No.: US 2023/0286874 A1
(43) Pub. Date: Sep. 14, 2023

(54) PROCESS FOR THE PRODUCTION OF POTASSIUM SULPHATE BASED FERTILIZERS

(71) Applicant: DESMET BALLESTRA S.P.A., Milano (IT)

(72) Inventors: Carlo Monesini, San Donato Milanese (MI) (IT); Stefano Signorini, Rosignano Marittimo (LI) (IT)

(21) Appl. No.: 18/018,296

(22) PCT Filed: Jul. 21, 2021
(86) PCT No.: PCT/IB2021/056578

§ 371 Date: Jan. 27, 2023

(30) Foreign Application Priority Data
Jul. 28, 2020 (IT) 102020000018238

(51) Int. Cl. C05D 1/02; C01D 5/08; C05G 1/00; B01D 33/00; B01D 21/26

(52) U.S. Cl. CPC C05D 1/02; C01D 5/08; C05G 1/00; B01D 33/00; B01D 21/262

(57) ABSTRACT

The present disclosure relates to a process for the production of potassium sulphate based mineral fertilizers, by means of an exchange reaction between potassium chloride and ammonium sulphate (2KCl+(NH₄)₂SO₄<→K₂SO₄+2NH₄Cl) in controlled conditions. The process, subject of the invention, makes it possible to obtain, in a single reaction stage, a crystalline product classifiable as low-chlorine-content mineral fertilizer, containing potassium sulphate, with K₂O in an amount of between 40% and 50% by dry weight, ammoniacal nitrogen in an amount of less than 5% by dry weight and chlorine in an amount of less than 3% by dry weight, with a high potassium-conversion efficiency (calculated as the ratio between what the amount found in the solid main product and the amount introduced as KCl to the reaction with ammonium sulphate) and a by-product, which can be used directly as NK fertilizer (containing nitrogen (N) and potassium oxide (K₂O) both in an amount comprised between 15% and 20% by dry weight) or as raw material for the production of complex fertilizers.

The present disclosure relates to a process for the production of potassium sulphate based mineral fertilizers, by means of the exchange reaction between potassium chloride and ammonium sulphate (2KCl+(NH₄)₂SO₄↔K₂SO₄+2NH₄Cl) conducted in specific and controlled conditions. The process forming the subject of the invention makes it possible to obtain, in a single reaction stage, a main product with a high potassium-conversion efficiency and a secondary product that can be used directly as fertilizer or as raw material for the production of complex fertilizers.

Fertilizers are technical means indispensable for soil improvement in agriculture. Among soil-improvement means, a fertilizer is that technical means that bestows upon the soil one or more nutritional elements that can be used by plants. The essential aim of fertilization is consequently to confer on the soil a nutritional level sufficient for feeding crops.

The most widely used classification of fertilizers is the one based upon the chemical composition, with reference to the content in one or more main elements of fertility. On the basis of the content of main macro-elements, fertilizers are distinguished into simple fertilizers, when they contain just one element (nitrogen, phosphorus, potassium), and complex or compound fertilizers when they contain two or three main macro-elements (referred to as binary or ternary fertilizers). Binary fertilizers are phospho-potassium (PK) fertilizers, nitrogen-potassium (NK) fertilizers, and nitrogen-phosphate (NP) fertilizers.

Like nitrogen, potassium is one of the main nutrients for plants and constitutes a non-negligible fraction of vegetal biomasses (2%-3% of the dry weight). Potassium is a fundamental element of plant biology being essential for absorption of water, transpiration, and also for the taste and shelf life of fruit.

Consequently, fertilizers containing potassium are essential.

For some crops, potassium can be added to the mixture of the components of the fertilizer directly as potassium chloride.

In other cases, the presence of chlorine is not, however, tolerated, and/or recommended, for instance, in the cultivation of tobacco, vines, and fruit plants in general. It hence becomes necessary to use low-chlorine-content fertilizers in which potassium is used in the form of a salt other than chloride, in general in the form of potassium sulphate.

Potassium sulphate can be obtained by extraction and purification of minerals of natural potassium, such as: sylvinite (KCl), kainite (MgSO4·KCl·H2O), langbeinite (K2SO4·2MgSO4) and carnallite (KCl·MgCl2·6H2O).

Generally potassium sulphate is prepared industrially starting from potassium chloride.

The maximum chlorine content allowed in this fertilizer must not, however, exceed 3%, and the minimum content of K₂O must be higher than 47% (Regulation EC No. 2003/2003). Consequently, the industrial processes used in the art for the preparation of potassium sulphate have mostly been aimed at maximizing conversion of potassium chloride into potassium sulphate, seeking in any case to obtain sufficiently pure potassium sulphate.

The Mannheim process for obtaining potassium sulphate is based upon the following reaction: 2KCl+H₂SO₄→K₂SO₄+2HCl (vap.).

Said process envisages the reaction between potassium chloride and sulphuric acid in an oven equipped with an internal mixing system. Temperatures of 600-700° C. are necessary to reach high levels of conversion into potassium sulphate; this entails that the materials for building the oven are subjected to particularly severe operating conditions. Hydrochloric acid in vapor phase is obtained as by-product, which must be absorbed with water and agitated in solution at 32%. Production and handling of hydrochloric acid, in vapor form and in solution, imposes on the production plant the need to meet the Seveso directive, regarding industrial activities involving the risk of major accidents.

U.S. Pat. No. 2,706,144 discloses the reaction between sulphur dioxide (SO₂), in vapor phase, and potassium chloride to obtain potassium sulphate and hydrochloric acid (Hargreaves process) according to the reaction:

SO₂+½O₂+H₂O+2KCl↔K₂SO₄+2HCl

The reaction takes place in a fluid-bed reactor fed by particles of potassium chloride fluidized by the reagent gases.

U.S. Pat. No. 4,342,737 discloses the reaction between potassium chloride and sulphuric acid at the melting point of potassium bisulphite (˜500° C.). In this way, it is possible to obtain, in a single reaction stage, a sulphate salt (mainly made up of potassium sulphate, but also containing potassium bisulphite and other salts) with a very low chlorine content.

U.S. Pat. No. 4,588,573 discloses a process for the production of potassium sulphate starting from the reaction between sulphuric acid and potassium chloride, through various steps of reaction and separation. The main reaction (at 130° C.) leads to the production of potassium bisulphite; this reaction is followed by a series of crystallizations/separations for conversion into potassium sulphate.

Further processes are based upon the solid/liquid balance reaction of the quaternary system K⁺, NH₄⁺, Cl⁻, SO4²⁻ described, for example, by Arthur E. Hill and Charles A. Loucks (The reciprocal salt pair (NH₄)₂SO₄+2KCl↔K₂SO₄+2NH₄Cl, J. Am. Chem. Soc. 1937, 59, 11, 2094-2098).

U.S. Pat. No. 6,315,976 describes a process for the production of potassium sulphate starting from ammonium sulphate, which envisages various reaction stages at low temperature (approximately 30-40° C.) and various solid/liquid separations; at the end of the process, relatively pure potassium sulphate is obtained with good yields, as well as a series of by-products to be discharged (slurry of CaSO₄, CaCO₃, etc.). This is a complex process with a marked environmental impact.

RU02307791 discloses a reaction between ammonium sulphate and potassium chloride in aqueous solution with formation of a mixed salt and subsequent purification of said salt by addition of KCl solution, with possible purification of the sulphate obtained by re-crystallization. The product obtained has a K₂O content of 52%.

CN 106335910 envisages a reaction between ammonium sulphate and potassium chloride at high temperature (80-110° C.) and separation of the salt formed (mainly potassium sulphate). Then, crystallization is carried out by cooling and separation of the solid by-product formed (mainly ammonium chloride). After separation of the solid, the mother liquors are recycled by dissolving the ammonium sulphate.

The processes referred to above are highly complex, have a poor potassium-conversion efficiency, involve considerable energy consumption, and some of them have a considerable environmental impact.

DE 102015003289 discloses a process for obtaining, from the reaction between ammonium sulphate and potassium chloride, potassium sulphate with high potassium content (K₂O≥50%), with less than 7.5% of ammonium sulphate. Moreover obtained from the process is a secondary product in solution (conversion solution) containing the product of reaction, i.e., ammonium chloride, together with large amounts of non-converted potassium chloride, the latter having been dosed in marked excess. The reaction is conducted at temperatures from 20° C. to 35° C., and, as already said, with an excess of potassium chloride (equiv KCl/equiv (NH₄)₂SO₄>1 and consequently equiv KCl/equiv NH₄Cl>1 in the conversion solution). The reaction system is moreover constituted by a two-stage reactor (mixed reactor and thickener).

The excess of potassium chloride used with respect to ammonium sulphate is necessary for the production of a potassium sulphate with a titer higher than 50% K₂O and a content of ammoniacal nitrogen of less than 1.6% (ammonium sulphate<7.5%). The result of this proposal has, however, as trade-off, a low potassium-conversion efficiency, which is around 0.5 (see Example No. 1 of DE 102015003289), an efficiency calculated as ratio between the K₂O contained in the potassium sulphate obtained and the K₂O contained in potassium chloride introduced into the reaction. In effect, the considerable amount of non-reacted KCl transfers into the mother-liquor by-products, with two negative consequences: a) the high amount of resulting by-product (approx. 1.62 T of dry by-product per 1 T of potassium sulphate), and b) the economic loss deriving from the fact that the KCl in excess, which is the most costly reagent, with respect to sulphate ammonium, loses its economic value in the by-product.

The aim of the present invention is hence to provide an industrial process for the production of potassium sulphate or of a fertilizer having a low chlorine content with a high potassium sulphate titer that will be simple and will present a good efficiency in relation to the potassium used, without any significant energy demand, and that will moreover minimize the amount of the by-product, and will be suitable for use in the fertilizer production cycles.

The above aim is achieved with the process of the invention, wherein solid potassium chloride and ammonium sulphate are made to react in water according to the following reaction:

2KCl+(NH₄)₂SO₄↔K₂SO₄+2NH₄Cl

in a single stage and in controlled conditions, as defined in claim 1, such as to obtain maximum conversion of KCl into crystalline potassium sulphate. In particular, the ratio between the amount of ammonium sulphate, potassium chloride and water is adjusted in the process of the invention to obtain a product containing for the most part crystalline potassium sulphate having a potassium titer (expressed as K₂O) comprised between 40% and 50%, preferably higher than 47%, for example comprised between 48% and 49%, and a concentration of ammoniacal nitrogen of less than 5%, preferably less than 3%, hence classifiable as potassium sulphate according to the Regulation (EC) No. 2003/2003.

In the process of the invention, the potassium-conversion efficiency, calculated as the ratio between the K₂O contained in the potassium sulphate present in the main product and the K₂O contained in the potassium chloride introduced into the reaction, is between 0.6 and 0.8, preferably higher than 0.65.

By means of the process according to the invention, it is moreover possible to recover a secondary product that can be valorized as NK fertilizer and can be used as it is, without any further chemico-physical treatment.

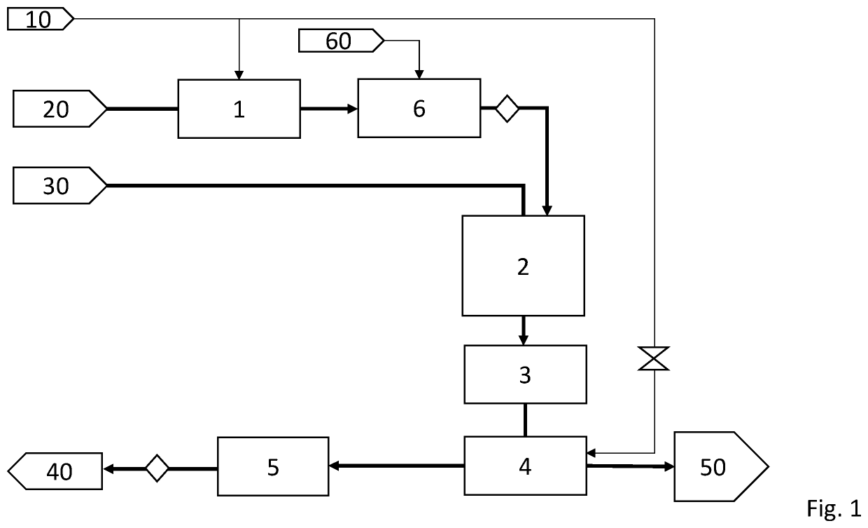

Further characteristics and advantages of the invention will emerge clearly from the description of a preferred, but non-exclusive, embodiment of the process, illustrated by way of non-limiting example in the attached FIG. 1, which illustrates a process according to the invention, as described in detail hereinafter.

The process of the invention comprises the following steps in succession:
a) getting potassium chloride and ammonium sulphate to react in water, preferably continuously, to obtain a product comprising solid potassium sulphate in suspension;
b) separating the solid potassium sulphate from the mother liquors to obtain a main product comprising potassium sulphate and a secondary product constituted by the mother liquors;
said process being characterised in that:
   potassium chloride is dosed in defect with respect to the amount required by the stoichiometry of conversion on the basis of the ammonium sulphate fed: the molar ratio between the reagents fed, expressed as ratio of K⁺ to NH₄⁺ equivalents, is in fact less than 1, preferably comprised between 0.7 and 1;
   for the reagents, the ratio between water moles and potassium equivalents is comprised between 9 and 15;
   the resulting reaction temperature is comprised between 10° C. and 50° C., preferably between 15° C. and 40° C.;
   the reaction time is comprised between 60 and 240 min; and
   the pH of the reaction mixture is comprised between 2 and 6, more preferably between 3 and 5.

In a preferred embodiment, ammonium sulphate is fed as aqueous solution, and potassium chloride as crystalline solid; preferably, ammonium sulphate is dissolved in water in a concentration comprised between 20% and 35% by weight, more preferably between 22% and 26% by weight, even more preferably approximately equal to the 25% by weight.

The aqueous solution of ammonium sulphate can be supplied by dissolving crystalline ammonium sulphate in water, in the desired concentration. Alternatively, the solution of ammonium sulphate can be supplied by effluent-treatment plants or by plants that produce it as by-product (plants for the production of caprolactam, monomeric methyl methacrylate, acetone cyanohydrin, coke, etc.), optionally subjected to chemico-physical purification prior to being fed to the process.

In an alternative embodiment, potassium chloride is fed as aqueous solution, and ammonium sulphate is supplied as crystalline solid.

Preferably, the reaction between ammonium sulphate and potassium chloride takes place in a single reactor equipped with a stirrer.

In step b) of separation of the solid potassium sulphate from the mother liquors, a crystallized solid essentially containing solid potassium sulphate is separated from the mother liquors. This separation preferably is obtained by means of centrifugation, or by means of a decanter centrifuge, or, even more preferably, with a belt filter so that the panel can be subjected to one or more countercurrent washings using water or aqueous solution of part of the product itself.

Preferably, the process according to the invention further comprises the step of:
c) drying the solid potassium sulphate separated from the mother liquors, thus obtaining the potassium sulphate end product. This end product can be used as fertilizer with a high potassium sulphate titer. Preferably, this drying step is carried out under a current of hot air.

The products that can be obtained with the process of the invention present specific chemical characteristics that distinguish them from the products known in the art.

Table 1 shows the percentage by weight (% w/w) of the various components detectable in a dry end product that can be obtained with the process of the invention.

TABLE 1

| | % w/w (dry) |
|---|---|
| K₂O | 40-50%, pref. 48-49% |
| N | <5%, pref. <3% |
| Cl | 0.3-3%, pref. <2.5% |
| SO₃ | 40-48% |

The secondary product, constituted by the mother liquors obtained after separation of the solid in step b) of the process of the invention, contains potassium, ammonium, sulphate, and chloride ions with a ratio of K⁺ to Cl equivalents of less than 0.5, preferably less than 0.4, even more preferably comprised between 0.25 and 0.32. This secondary product can be valorized in an integrated cycle of production of NPK compound fertilizers, or transformed into a solid NK fertilizer by evaporative crystallization, or used as it is for the production of liquid fertilizers.

Table 2 shows the weight percentage (% w/w) of the components detectable in the secondary product (dry product) that can be obtained with the process of the invention.

TABLE 2

| | % w/w (dry) |
|---|---|
| K₂O | 15-20% |
| N | 15-20% |

Advantageously, the above secondary product has a balanced content of potassium and nitrogen.

Represented graphically in FIG. 1 is a process according to a preferred embodiment of the invention, wherein:
ammonium sulphate (20) is fed in crystalline solid form to a container (1) in which it is subjected to dissolution in water (10) to yield an aqueous solution of ammonium sulphate; the aqueous solution is then sent to a buffer (6) for titration and for adjustment of the pH by means of appropriate addition of acids or bases (60); the aqueous solution of ammonium sulphate is then fed to a reactor (2) together with crystalline potassium chloride (30) in the appropriate molar ratios. The conditions of the reaction are controlled, according to the invention, to obtain a suspension of the crystalline solid reaction product containing mainly potassium sulphate. This suspension is sent to a buffer (3) and then to a separator (4), preferably of the belt filter type, for separation of the solid from the mother liquors; one or two countercurrent washings with water, or, preferably, with an aqueous solution of the same product recovered from the filter are carried out on the filter. The separated solid is sent to a dryer (5), thus obtaining the end product (40).

The secondary product constituted by the mother liquors (50) is made available for possible further processing.

### EXAMPLES

### Example 1

An amount of 82.9 g of ammonium sulphate (98.9%), produced by a plant for recovery of ammonia coming from vapor stripping by abatement with sulphuric acid was weighed and dissolved in distilled water. The amount of water for dissolving the ammonium sulphate was 249.7 g.

The solution had a pH of 3.5 and a temperature of 24° C.

The solution was put in a beaker and stirred with a magnetic stirring bar and potassium chloride (with a degree of 62% as K₂O) was slowly added to said solution. Introduction of potassium chloride lasted 6 min. The total amount of potassium chloride added was 80.1 g. The reaction was left to proceed under gentle stirring for 120 min. At the end of the reaction the temperature was 30° C.

The primary product of the reaction was filtered on paper and in vacuum conditions, and not washed. A moist crystalline solid was obtained on the filter paper, as well as a secondary product constituted by a limpid solution of mother liquors, which were collected in a flask (306.7 g).

The solid product on the filter was dried in a ventilated oven at 100° C. and weighed: 74.1 g.

The end product thus obtained was subjected to chemical analysis, with the following results:
Potassium (K₂O): 48.2%
N (ammoniacal nitrogen): 2.5%
Chlorine 3.2%

The secondary product thus obtained was found to have the following composition (by dry weight):
Potassium (K₂O): 15.5%
N (ammoniacal nitrogen): 17.0%
Chlorine 40.1%

It should be noted that, in this example, the operation was conducted with a defect of KCl with respect to (NH₄)₂SO₄ (approx. 0.86 equiv KCl/equiv (NH₄)₂SO₄) and a by-product was obtained in which the ratio between the amounts of (unreacted) KCl and NH₄Cl (produced by the reaction) was far less than 1 (equivalent ratio of 0.41 and weight ratio of 0.57).

The potassium-conversion ratio, as already defined, was 0.72.

The amount of dry by-product obtained was 1.2 T/T of main product.

### Example 2

The solution of ammonium sulphate produced by abatement of ammonia from stripping vapor of an ammoniacal effluent was used.

The solution had an ammonium-sulphate titer of 32% and a pH of 3.1, and presented a limpid appearance, with a slightly straw-colored.

Of the above solution 285 g were taken, to which 56 g of distilled water were added. The solution thus obtained was put in a beaker and stirred as in the previous example.

This was followed by gradual addition of 88 g of solid potassium chloride, and the product was left to react for 110 min.

The crystal suspension coming from the reaction was subjected to filtration in vacuum conditions on paper. The panel of crystals was washed by spraying 15 g of distilled water on the surface, and then dried in a ventilated oven at 100° C. and weighed: 84.2 g.

The dried product was subjected to chemical analysis, and the following results were obtained:
Potassium (K₂O): 48.1%
N (ammoniacal nitrogen): 2.4%
Chlorine: 2.2%

The secondary product constituted by the mother liquors after separation of the solid was found to have the following composition (by dry weight):
Potassium (K₂O): 15.7%
N (ammoniacal nitrogen): 19.2%
Chlorine 44.7%

1. A process for the production of potassium sulphate based fertilizers having a low chlorine content, comprising the following steps in succession:
(a) feeding potassium chloride and ammonium sulphate to a reactor and causing them to react in water, thus obtaining a reaction product containing solid potassium sulphate in suspension; and
(b) separating the solid potassium sulphate from the mother liquors, thus obtaining a main product comprising potassium sulphate and a secondary product comprising the mother liquors;
said process being characterized in that:
the ratio of potassium (K⁺) to ammonium (NH₄⁺) equivalents in reagents fed to the reactor is less than 1;
the ratio of water moles to K+ equivalents in reagents fed to the reactor is comprised between 9 and 15;
the resulting reaction temperature is comprised between 10° C. and 50° C.;
the reaction time is comprised between 60 and 240 minutes;
the pH of the reaction mixture is comprised between 2 and 6.

2. The process according to claim 1, wherein the ammonium sulphate is fed as an aqueous solution and the potassium chloride as a crystalline solid.

3. The process according to claim 2, wherein the concentration of ammonium sulphate in the aqueous solution is comprised between 20% and 35% by weight.

4. The process according to the claim 2, wherein the aqueous solution of ammonium sulphate is supplied by a chemical plant or by an effluent treatment plant, optionally subjected to a chemico-physical purification prior to being fed to the reactor.

5. The process according to claim 1, wherein the separation of the solid ammonium sulphate from the mother liquors takes place by means of a pusher centrifuge, or by means of a decanter centrifuge, or by means of a belt filter.

6. The process according to claim 1, furthermore comprising the subsequent step of:
c) drying the main product obtained in step b), thus obtaining an end product consisting substantially of potassium sulphate.

7. The process according to claim 1, wherein the secondary product is sent as it is to an integrated cycle for the production of compound fertilizer, or is transformed into a solid fertilizer by means of evaporative crystallization, or is formulated as a liquid fertilizer.

8. The process according to claim 1, wherein, in step a) potassium chloride and ammonium sulphate are reacted in water either continuously or in batches.

9. A use of the main product obtainable with the process of claim 1 as an NK fertilizer.

10. A use of the end product obtainable with the process of claim 6 as an NK fertilizer.

11. A use of the secondary product obtainable with the process of claim 1 as an NK fertilizer.
